(19) United States
(12) Patent Application Publication
(10) Pub. No.: US 2025/0151108 A1
(43) Pub. Date: May 8, 2025

(54) SYSTEMS AND METHODS FOR COVERAGE ENHANCEMENT IN NON-TERRESTRIAL NETWORK (NTN)

(71) Applicant: ZTE CORPORATION, Shenzhen (CN)

(72) Inventors: Junli LI, Shenzhen (CN); Nan ZHANG, Shenzhen (CN); Wei CAO, Shenzhen (CN); Fangyu CUI, Shenzhen (CN)

(73) Assignee: ZTE CORPORATION, Shenzhen (CN)

(21) Appl. No.: 19/017,711

(22) Filed: Jan. 12, 2025

Related U.S. Application Data
(63) Continuation of application No. PCT/CN2023/072800, filed on Jan. 18, 2023.

(51) Int. Cl. H04W 74/00; H04W 74/0833

(52) U.S. Cl. CPC H04W 74/006; H04W 74/0833

(57) ABSTRACT

Presented are systems and methods for coverage enhancement in non-terrestrial network (NTN). A wireless communication device (e.g., UE) may receive a random access response (RAR) transmission that includes an indication indicating a maximum repetition number (repNum) of RAR transmissions for at least the wireless communication device from a wireless communication node (e.g., BS). The wireless communication device can determine, using the repNum, a time domain location of a transmission resource on which a Msg.3 transmission is to be transmitted in response to the RAR transmission.

### CROSS-REFERENCE TO RELATED APPLICATION

This application claims the benefit of priority under 35 U.S.C. § 120 as a continuation of PCT Patent Application No. PCT/CN2023/072800, filed on Jan. 18, 2023, the disclosure of which is incorporated herein by reference in its entirety.

### TECHNICAL FIELD

The disclosure relates generally to wireless communications, including but not limited to systems and methods for coverage enhancement in non-terrestrial network (NTN).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., UE) can receive/obtain/acquire a random access response (RAR) transmission that includes an indication indicating a maximum repetition number (repNum) of RAR transmissions for at least the wireless communication device, from a wireless communication node (e.g., base station (BS), gNB, and/or non-terrestrial device). The wireless communication device can determine, using the repNum, a time domain location of a transmission resource on which a Msg.3 transmission is to be transmitted, in response to the RAR transmission.

In some implementations, the indication can be in a two-bit field. In some implementations, the indication can indicate that the wireless communication device is to receive multiple RAR transmissions. In some implementations, repNum can have a value that is same as a maximum repetition number that is configured or defined via a system information block (SIB) signaling, a radio resource control (RRC) signaling, or a media access control control element (MAC CE) signaling.

In some implementations, to determine the time domain location, the wireless communication device can determine an offset using the repNum. The wireless communication device can determine the time domain location by adding the offset to a location of a first or an earliest random access response (RAR) window of the RAR transmissions.

In some implementations, the wireless communication device can determine a number of repetitions required by wireless communication device (requiredRepNum_UE) through measuring a synchronization signal block (SSB) or one or more other signals. The wireless communication device can determine the offset using the repNum, the requiredRepNum_UE, and a length of a RAR window.

In some implementations, the wireless communication device can determine a number of repetitions required by wireless communication device (requiredRepNum_UE). The wireless communication device can determine the offset using the repNum or the requiredRepNum_UE, and a length of a RAR window, when the repNum matches (or is equal to) the requiredRepNum_UE.

In some implementations, the wireless communication node may send a Msg.4 transmission to only one of a plurality of wireless communication devices that each sent a Msg.3 transmission to the wireless communication node. In some implementations, the wireless communication device can determine failure by/of a number of RAR detection attempts that exceeded the repNum. The wireless communication device can determine, responsive to the failure, that a random access (e.g., performed or attempted by the wireless communication device) has failed.

In some implementations, the wireless communication device can send a Msg.3 transmission to the wireless communication node. The Msg.3 can include an indication of an offset (TC-RNTI_offset) to a temporary cell radio network temporary identifier (TC-RNTI), the TC-RNTI_offset being unique/specific to the wireless communication device. In some implementations, the wireless communication device can determine a number of repetitions required by wireless communication device (requiredRepNum_UE). The TC-RNTI_offset can have a value that is: same as a value of the requiredRepNum_UE, or is a function of the value of the requiredRepNum_UE.

In some implementations, the wireless communication node can scramble (e.g., encode or encrypt) a content of a Msg.4 transmission using the TC-RNTI combined with the TC-RNTI_offset. In some implementations, the wireless communication device can determine to adopt the TC-RNTI combined with the TC-RNTI_offset, as a cell radio network temporary identifier (C-RNTI) of the wireless communication device, responsive to: receiving the Msg.4 transmission from the wireless communication node; or descrambling (e.g., decoding or decrypting) the Msg.4 transmission successfully using the TC-RNTI combined with the TC-RNTI_offset; or receiving an indication in the Msg.4 transmission from the wireless communication node, that validates adoption of the TC-RNTI combined with the TC-RNTI_offset, as the C-RNTI of the wireless communication device.

In some implementations, the wireless communication device can send a respective Msg.4 transmission to each of a plurality of wireless communication devices that sent a respective Msg.3 transmission to the wireless communication node.

At least one aspect is directed to a system, method, apparatus, or a computer-readable medium of the following. A wireless communication node can send/transmit/provide a RAR transmission that includes an indication indicating a maximum repetition number (repNum) of RAR transmissions for at least a wireless communication device to the wireless communication device. The wireless communication device can determine, using the repNum, a time domain location of a transmission resource on which a Msg.3 transmission is to be transmitted in response to the RAR transmission.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of a non-terrestrial network (NTN), in accordance with some embodiments of the present disclosure;

FIG. 4 illustrates an example of an access delay in communication between the UE and the BS, in accordance with some embodiments of the present disclosure;

FIG. 5 illustrates an example implementation of one or more UEs sending Msg.3 to the BS and one of the UEs receiving a response from the BS, in accordance with some embodiments of the present disclosure;

FIG. 6 illustrates an example implementation of the UEs sending Msg.3 to the BS and receiving a response from the BS, in accordance with some embodiments of the present disclosure; and

FIG. 7 illustrates a flow diagram of an example method for coverage enhancement in NTN, in accordance with an embodiment of the present disclosure.

### DETAILED DESCRIPTION

### 1. Mobile Communication Technology and Environment

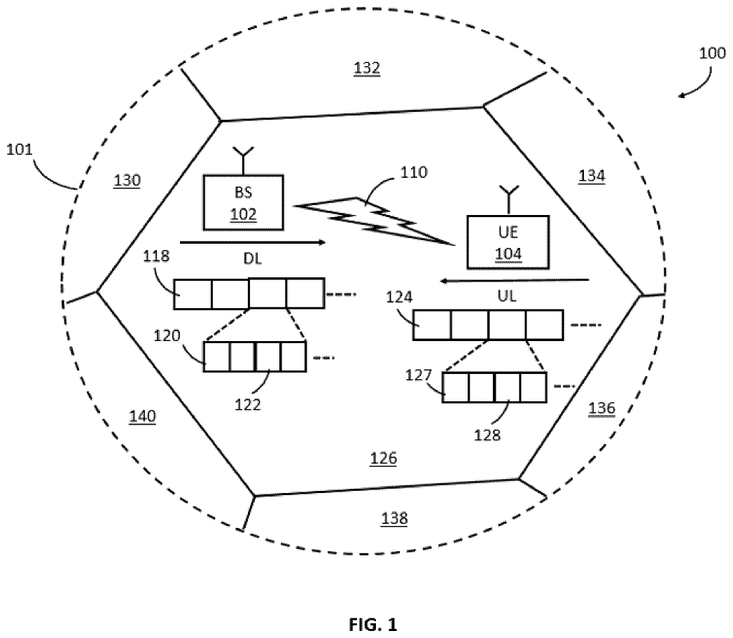

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

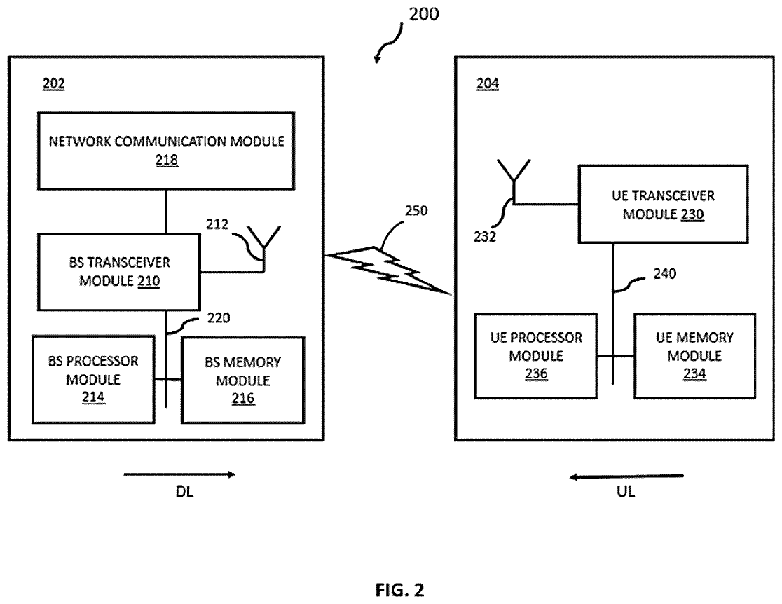

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Coverage Enhancement in NTN

In a certain non-terrestrial network (NTN), the UE 104 may acquire/obtain its position/location via a global navigation satellite system (GNSS). Individual UEs 104 may be configured with different hardware and/or software components, resulting in varying capabilities in supporting communication with the BS 102 and/or a non-terrestrial component (e.g., satellites). Based on the capabilities of individual UEs 104, the UEs 104 can be capable of supporting relatively higher coverage zones (e.g., longer distance) or relatively lower zone (e.g., shorter distance). Certain UEs 104 (e.g., with relatively lower capabilities) may experience coverage issues, such as packet drop, network interference, etc., due to the distance between the UE 104 and at least one of the satellites or the BS 102 being greater than its optimal coverage distance. To address/resolve the potential coverage issue of certain systems, the systems and methods of the technical solution discussed herein can utilize message repetition to improve coverage performance in communication between the UE 104 and the BS 102 (and/or the satellite(s)). Further, in certain systems (e.g., terrestrial network systems), the repetition of random access procedure, including physical downlink control channel (PDCCH), may not be supported for random access transmission. Therefore, the systems and methods of the technical solution can provide features or operations discussed herein to support a method employing random access response (RAR) (e.g., including PDCCH) repetition for random access transmissions to enhance/improve network coverage for the UEs 104 in NTN.

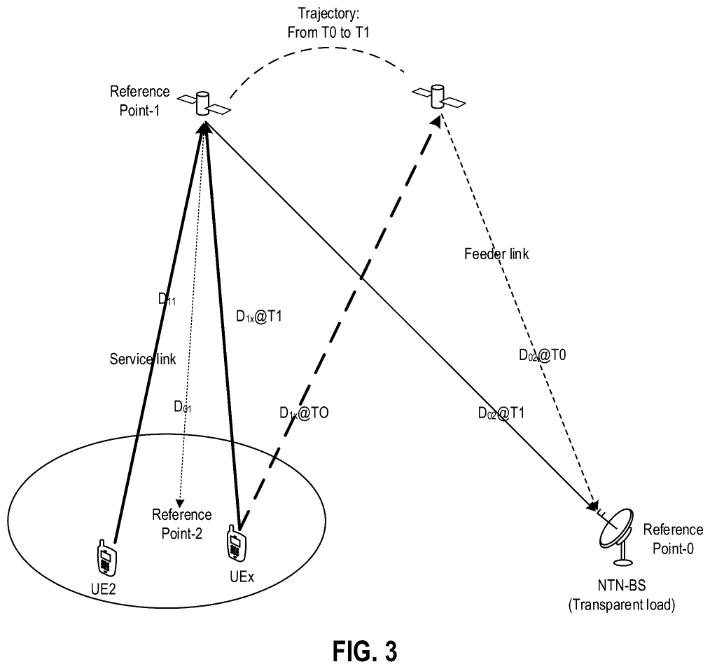

FIG. 3 illustrates an example structure of a transparent NTN, in accordance with some embodiments of the present disclosure. A link between a UE (e.g., a user equipment, the UE 104, the UE 204, a mobile device, a wireless communication device, a terminal, etc.) and a satellite can be a service link. A link between a BS (e.g., a base station, the BS 102, the BS 202, a gNB, an eNB, a wireless communication node, etc.) and a satellite can be a feeder link and can be common for all UEs within the same cell. To improve/enhance the coverage performance for the UE 104 in NTN, the systems and methods discussed herein can enable periodic repetition of transmissions or multiple repeated transmissions of RAR (e.g., PDCCH).

In various configurations to improve the coverage enhancement, the systems and methods can extend the random access response (RAR) window (e.g., time duration to receive a response from the BS 102) for Msg.2 (e.g., sometimes referred to as an RAR), for instance, additionally or alternatively to enabling transmission repetition. For example, to extend the RAR window, the network (e.g., BS 102, gNB, satellite, etc.) can indicate/send/provide the number of repetitions of RAR to the UE 104. The UE 104 can determine/compute one or more extended RAR windows according to a product of the original (or currently configured) RAR window and the repetition number of RAR (e.g., multiply the original RAR window by the repetition number). In another example, to extend the RAR window, the network can indicate the number of RAR repetitions and period/cycle/duration between each PDCCH repetition to the UE 104. In this case, the UE 104 can extend the RAR window by an offset. The offset can be the product of the repetition number and the repetition period, for example.

The UEs 104 can be positioned at a certain elevation angle (e.g., distance and/or direction) in relation to the satellite and/or the BS 102. Based on the location of the UE 104, the satellite, and/or the BS 102, the UE 104 may experience different path loss, packet drop, interference, and/or other signal propagation error. Therefore, it may be desirable to repeat certain transmissions to the UE 104 to enhance the (e.g., signal or communication) coverage. Because of the different capabilities (e.g., channel environments) supported by individual UEs 104, some UEs 104 may desire or expect more or fewer transmission repetitions to mitigate performance loss. In some cases, certain UEs 104 with relatively high capability may not desire repeated transmissions, or may expect a single transmission. Therefore, different UEs 104 may be configured with different repetition configurations (e.g., repNum, corresponding to the maximum number of repetitions).

In cases of individual UEs 104 having different repetition configurations (e.g., repNum_UE1<repNum_UE2, for a UE1 and a UE2), if multiple UEs 104 send/transmit/signal/communicate the same random access preamble sequence with the same preamble index on the same time-frequency resource at the same time to the BS 102, the BS 102 may detect different peaks/signals (e.g., correlation, or other operations, of the random access sequence by the BS 102 or the satellite), but may identify the different peaks as a random access request from one UE 104. For instance, depending on the distance between the UE 104 and the BS 102 or the satellite, the position of the peak obtained by the BS 102 or the satellite can have a certain (different) deviation. Hence, for the BS 102 to accurately/clearly distinguish the UEs 104 transmitting the random access requests, the UEs 104 can use different random access sequences to initiate the random access. For purposes of providing examples herein, UE1 can represent a first UE and UE2 can represent a second UE in communication with one or more satellites and/or the BS 102. UE1 and UE2 may be in the same cell.

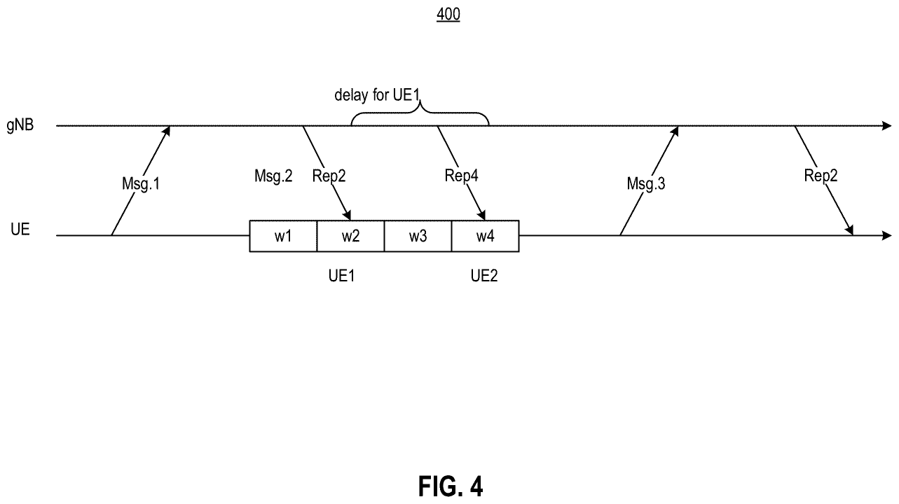

Referring to FIG. 4, an example of an access delay in the communication between the UE 104 and the BS 102 is depicted. In the situation described above, if the repetition number configured by the network is repNum_UE1 (e.g., a predetermined number of repetitions similar to the maximum repetition of UE1) and UE2 expects a greater number of repetitions compared to UE1 (e.g., repNum_UE2>repNum_UE1), the UE2 may fail to decode RAR (e.g., Msg.2) from the BS 102 (e.g., due to the fewer number of repetitions than desired), causing UE2 access failure. As such, by configuring a relatively large number of repetitions, the premature access failure of UE2 (or other UEs 104 with similar or lower capabilities) can be mitigated or avoided. For example, if the repetition number is configured as repNum_UE2, the UE1 and UE2 are based on contention-based random access. However, because certain UEs 104 (e.g., UE1) can satisfy the coverage criteria with fewer repetitions (e.g., less number of transmissions from the BS 102) compared to the configured repetition number by the BS 102 (e.g., repNum_UE2 in this case), the access delay for the certain UEs 104 may be increased, such as shown in FIG. 4. The systems and methods of the technical solution can execute the features or operations discussed herein to enhance the coverage for accessing the network (e.g., via transmission repetitions) while minimizing or avoiding the access delay for individual UEs 104 (e.g., UEs 104 with relatively higher capabilities and/or lower repNum compared to the repNum configured by the network).

In various implementations, the UE 104 can measure the synchronization signal block (SSB) or one or more other signals sent/provided/transmitted by the network (e.g., BS 102 and/or satellite). The UE 104 can utilize the measurement of the signal(s) to compute/calculate or determine the number of repetitions that satisfy a desired coverage (e.g., coverage requirement or criteria). The computed number of repetitions that satisfy the coverage can be named/indicated/referred to as “requireRepNum_UEx”, where “UEx” can represent the respective UE 104 performing the computation, such as UE1, UE2, etc., for example. For UEs 104 with different coverage requirements (e.g., more or less number of repetitions), the following associated definition can be provided:
1) The desired/required repetition number of PDCCH for UE1 can be referred to as “requireRepNum_UE1”. The required repetition number of PDCCH for UE2 can be referred to as “requireRepNum_UE2”.
2) The uplink (UL) grant time-frequency resource indicated/informed in the first RAR (e.g, Msg.2) received in an initial RAR window (w1) can be an initial resource.
3) The maximum number of repetitions can be configured or predefined by at least one of SIB signaling, RRC signaling, and/or MAC signaling. The maximum number of repetitions can be used by the UE 104 to avoid having a permanent state of the UE 104 detecting or monitoring for RAR. Responsive to detecting a number of received transmissions corresponding to the requireRepNum_UEx (e.g., required number of repetitions configured by the network), the UEs 104 can merge/combine (over the repeated transmissions of RAR) and decode the RAR. In some implementations, the UEs 104 can merge and decode RAR responsive to receiving a number of transmissions corresponding to the maximum number of repetitions configured for the UE 104. In some cases, if the decoding of the RAR fails, the UE 104 may declare/inform/indicate that the random access has failed and/or the random access is re-initiated/restarted, such as to avoid the UE 104 being in a permanent state of detecting RAR (in attempts to successfully decode RAR).

In situations when multiple UEs 104 (e.g., two UEs 104 provided for examples herein) with different coverage requirements (e.g., based on the capability of individual UEs 104) send/transmit/signal the same random access preamble sequence on the same time-frequency resource at the same time to the network (e.g., BS 102 and/or satellite), the network can repetitively transmit the same RAR to the UEs 104 to avoid/minimize potential coverage issues.

### Example Implementation 1

In various arrangements, the UE 104 can receive Msg.2 transmission or random access response (RAR) transmission from the BS 102. Herein, the terms Msg.2 transmission and RAR transmission can be applicable and/or used interchangeably with one another. The RAR transmission can include a bit field (e.g., an indication) indicating a maximum repetition number (repNum) of RAR transmissions to transmit to the UE 104. The RAR (e.g., bit field of the RAR that includes the RepNum) can be used to indicate the UL grant time-frequency resource offset (e.g., implicit indication). For example, the RAR transmission can include a 2-bit field (e.g., indication can be in the 2-bit field) for indicating the maximum repetition number for the UEs 104, where the two bits (e.g., represented as ‘xx’) can indicate that the UEs 104 are expecting to receive multiple RAR transmissions.

In various implementations, the value of the repNum can be the same as a maximum repetition number that is configured or predefined via at least one of an synchronization signal block (SIB) signaling, a radio resource control (RRC) signaling, and/or a media access control control element (MAC CE) signaling from the BS 102 and/or the satellite. For example, the repNum indicated/provided/sent via the RAR transmission can correspond to the configured maximum repetition number (e.g., previously/historically sent by the BS via RRC or other signalings, and/or stored by the UE 104).

In some implementations, if the repNum is different from the predefined maximum repetition number, the UE 104 may determine to use one of the repNum recently received via the RAR transmission or the predefined maximum repetition number historically/previously received from the BS 102, according to the configuration of the UE 104, for example. In certain arrangements, the predefined/configured maximum repetition number may not exist or may not be informed/indicated to the UE 104 (e.g., not provided by the BS 102 via at least one of the signalings). In such cases, the condition of the repNum being equal to the predefined/configured maximum repetition number may not apply.

The transmission resource corresponding to Msg.3 can include an indication of a resource offset. For UE1 and UE2 (among other UEs 104) with different coverage requirements, requireRepNum_UE1 can be configured for UE1, requireRepNum_UE2 can be configured for UE2, and the maximum number of repetitions (repNum) can be configured/provided in RAR. Responsive to the UE1 receiving at least one RAR transmission (e.g., two repetitions for UE1 E2 in this example) from the BS 102 (e.g., gNB or wireless communication node), the UE1 can send/provide Msg.3 to the BS 102 on the time-frequency resource according to an offset of (e.g., after the duration computed by) (requireRepNum_UE1−1)×RARWindowLength corresponding to the UL grant time-frequency resource location receiving in the first RAR window. Responsive to the UE2 receiving at least one RAR transmission (e.g., four repetitions for UE2 in this example) from the BS 102, the UE2 can send Msg.3 to the BS 102 on the time-frequency resource according to an offset of (requireRepNum_UE2−1)×RARWindowLength. The RARWindowLength (e.g., length/duration of the RAR window) can be provided to the UEs 104 by the network via RRC signaling, SIB signaling, among other type of signalings.

According to the above formula, the UEs 104 can determine the offset for a time domain location (e.g., by adding a location of the earliest RAR window of the RAR transmission and the offset) using at least one of the repNum, the requiredRepNum_UEx, and/or a length of the RAR window, among other variables related to the time domain location for transmission of Msg. 3. In some cases, the repNum can be the requireRepNum_UEx of the respective UE 104 receiving the RAR transmission. When repNum=requireRepNum_UEx, the respective UE 104 (e.g., UEx) can send Msg.3 on the time-frequency resource according to an offset of ([repNum or requireRepNumUEx]−1)×RARWindowLength corresponding to the UL grant time-frequency resource location receiving in the first RAR window. In this case, the UEs 104 can determine the offset for the time domain location using the repNum or the requiredRepNum_UEx, and a length of a RAR window, for example, when the repNum matches (or is equal to) the requiredRepNum_UEx.

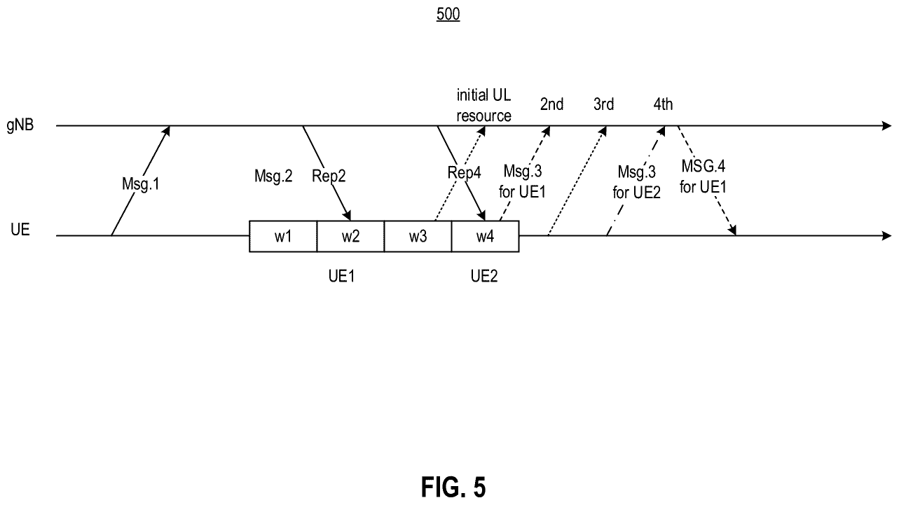

In various implementations, the BS 102 may reply/respond to the Msg.3 transmission of (only) one UE 104 (e.g., the UE 104 which can adopt/obtain a temporary cell-radio network temporary identifier (TC-RNTI) as its unique C-RNTI) so as to avoid potential confusion of multiple UEs 104 adopting the same TC-RNTI (e.g., if the BS were to instead reply to each of these multiple UEs). For example, as an example in FIG. 5, the BS 102 can respond (e.g., transmit Msg.4 transmission) to the Msg.3 transmission of one of the UEs 104 (e.g., UE1 in this example).

Referring to FIG. 5, depicted is an example implementation of the UEs 104 (e.g., UE1 and UE2) sending Msg.3 to the BS 102, and subsequently one of the UEs 104 receiving a response (e.g., Msg.4) from the BS 102 and/or the satellite. As shown, the UE1 may have/determine a requireRepNum_UE1 of 2 (e.g., requireRepNum_UE1=2) transmissions to satisfy the coverage requirements, and UE2 may have/determine requireRepNum_UE2 of 4 (e.g., requireRepNum_UE1=4) transmissions to satisfy the coverage requirements. A bit field in RAR indicating the maximum repetition number of the UEs 104 can be repNum=4.

In this example, the UE1 can send Msg.3 on the time-frequency resource at an offset of (2−1)×RAR WindowLength corresponding to the UL grant time-frequency resource location receiving in the first RAR window, for instance, using the formula (require RepNum_UEx−1)×RARWindowLength to represent the offset simply. Further, the UE2 can send Msg.3 on the time-frequency resource at an offset of (4−1)×RARWindowLength corresponding to the UL grant time-frequency resource location receiving in the first RAR window, for instance, using the formula ([repNum or requireRepNumUEx]−1)×RARWindowLength to represent the offset because repNum=requireRepNumUEx. As shown in the example, the BS 102 can send a response (e.g., a Msg.4 transmission) to only one of the UEs 104 that each sent a Msg.3 transmission to the BS 102. For instance, given the RepNum configuration of the BS 102 in the RAR message, the BS 102 can perform a blind detection responsive to receiving the Msg.3 from the UEs 104 to detect the Msg.3 sent from UEs 104 with different coverage requirements (e.g., time is different).

In some implementations, the UE 104 may detect that the number of RAR transmissions exceeds the predefined maximum number of repetitions (repNum) (e.g., the number of Msg.2 detection attempts failure exceeds the repNum). Responsive to the detection/failures, the UE 104 can determine that the random access has failed. The UE 104 may re-attempt the random access procedures to access the network subsequent to the previous random access failure.

### Example Implementation 2

In various arrangements, a bit field included in RAR can indicate/provide the maximum repetition number (repNum) of the UEs 104. The bit field can be used to at least implicitly indicate UL grant time-frequency resource offset (e.g., relative to w1, the first RAR window for Msg.2). Based on the indication from the bit field, the bit field can enable/allow the BS 102 to perform Msg.4 transmissions responsive to receiving the Msg.3 from different UEs 104 that has been configured with multiple RAR repeated transmission responses. The Msg.3 transmission can include a bit field (e.g., indication) indicating a value or an offset of “TC-RNTI offset” specific/unique to the UE 104 that sent the Msg.3 transmission. The offset (e.g., TC-RNTI_offset) indicated by the bit field of Msg.3 transmission can be associated with (e.g., is a function of) the required repetition number (requireRepNum_UEx). In some cases, the TC-RNTI_offset can include a value that is the same as a value of the required repetition number (e.g., requireRepNum_UEx). Subsequently, the BS 102 can scramble (e.g., encode or encrypt) Msg.4 (e.g., a content of Msg.4 transmission) using the combination of the TC-RNTI and TC-RNTI_offset, for instance, TC-RNTI+TC-RNTI_offset. In this case, the UE 104 can descramble (e.g., decode or decrypt) Msg.4 transmission using a similar combination of TC-RNTI+TC-RNTI_offset to confirm/validate/complete/verify the upgrade/enhancement/update to “TC-RNTI +TC-RNTI_offset” as the CRNTI or identifier of UE 104.

In some implementations, the Msg.4 transmission may include 1 bit (e.g., in a bit field) to confirm/validate/indicate the upgrade to “TC-RNTI+TC-RNTI_offset”. For instance, the 1-bit or the bit field can include a “1” (or a “0” depending on the transmission configuration) to indicate that the upgrade to “TC-RNTI+TC-RNTI_offset” is confirmed, or a different value to indicate that the upgrade is denied or not confirmed.

For example, the TC-RNTI_offset can be sent/provided/indicated in the Msg.3 transmission. The confirming message may be sent implicitly or explicitly in a corresponding Msg.4 transmission (responsive to the Msg.3 transmission). The approaches or operations to confirm that the UE 104 can update to the TC-RNTI with the offset, and can include at least one of the following:
i) When the UE 104 (e.g., UEx) receives a Msg.3 reply/response (e.g., Msg. 4 transmission) from the BS 102, the UE 104 can confirm that the TC-RNTI can be updated to the TC-RNTI with the offset.
ii) If the UE 104 can successfully descramble Msg.4 using “TC-RNTI+TC-RNTI_offset”, the UE 104 can confirm or establish “TC-RNTI+TC-RNTI offset” as its C-RNTI.
iii) If the UE 104 can receive Msg.4 with a 1-bit indicator from the BS 102 that indicates a confirmation (e.g., instead of or rather than an indication of a failure or rejection), the UE 104 can confirm “TC-RNTI+TC-RNTI offset” as its C-RNTI.

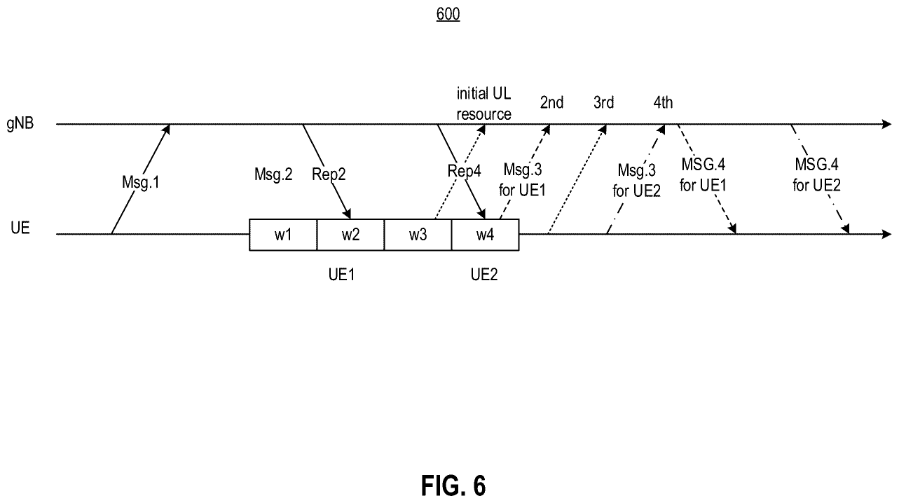

Referring to FIG. 6, depicted is an example implementation of the UEs 104 sending Msg.3 to the BS 102 and, respectively, receiving a response from the BS 102. In various implementations, a 2-bit field for the maximum repetition number (repNum) can be configured or defined, where the two bits ('xx') can indicate that the UE 104 is expected to receive multiple RAR transmissions. The transmission resource (e.g., time domain location) for Msg.3 can be based on resource offset associated with the bit field indicator RAR transmission. For UE1 and UE2 with different coverage requirements, requireRepNum_UE1 can be determined for UE1, requireRepNum_UE2 can be determined for UE2, and the maximum number of repetitions (repNum) can be configured in RAR received by the UE1 and UE2.

Subsequent to receiving RAR transmission, the UE1 can send Msg.3 on the time-frequency resource according to an offset of (e.g., after the duration computed by) (requireRepNum_UE1−1)×RARWindowLength correspond to the UL grant time-frequency resource location receiving in the first RAR window, and the UE2 can send Msg.3 on the time-frequency resource at (requireRepNum_UE2−1)×RARWindowLength according to an offset of (e.g., after the duration computed by) (requireRepNum_UE2−1)×RARWindowLength correspond to the UL grant time-frequency resource location receiving in the first RAR window. When repNum=requireRepNum_UEx, the UEx can send Msg.3 on the time-frequency resource according to an offset of ([repNum or requireRepNum_UEx]−1)×RARWindowLength corresponding to the UL grant time-frequency resource location receiving in the first RAR window. The BS 102 can receive the Msg.3 transmissions from UE1 and UE2. Respectively, the BS 102 can send Msg.4 transmissions to UE1 and UE2 (e.g., at different time domain locations) responsive to receiving the Msg.3 transmissions from the different UEs 104. After receiving the Msg.4 transmission(s) as a response from the BS 102, the UE 104 can convert, establish, or utilize the “TC-RNTI+TC-RNTI_offset” (for example, or some other function/combination of TC-RNTI and TC-RNTI_offset) as its C-RNTI, for instance, to complete the random access process and improve the channel capacity or coverage.

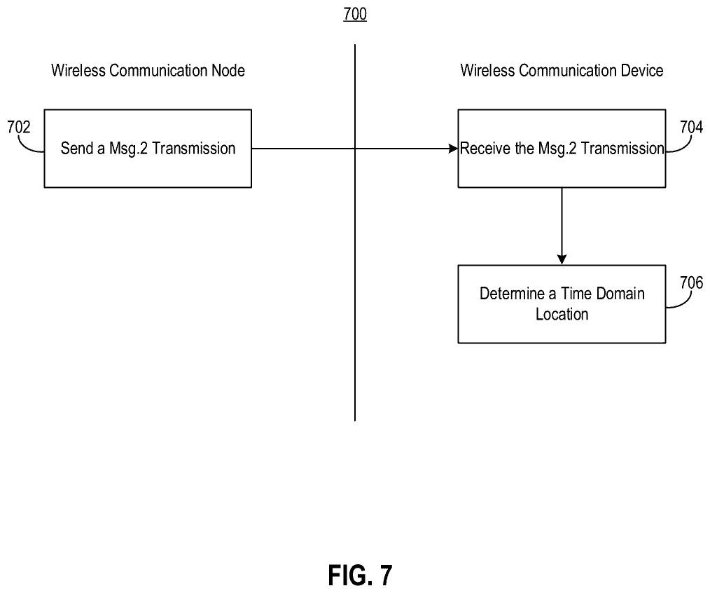

FIG. 7 illustrates a flow diagram of an example method 700 for coverage enhancement in NTN. The method 700 may be implemented using any one or more of the components and devices detailed herein in conjunction with FIGS. 1-6. In brief overview, the method 700 may be performed by at least one wireless communication device (e.g., a UE or terminal device), at least one wireless communication node (e.g., a BS, gNB, or access network equipment), at least one satellite, etc., in some embodiments. Additional, fewer, or different operations may be performed in the method 700 depending on the embodiment. At least one aspect of the operations is directed to a system, method, apparatus, or a computer-readable medium.

At operation 702, a wireless communication node can send/transmit/communicate a RAR transmission to at least one wireless communication device (or multiple wireless communication devices). The RAR transmission can include an indication indicating a maximum repetition number (repNum) of RAR transmissions for at least the wireless communication device, among other wireless communication devices (e.g., for all UEs). At operation 704, the wireless communication device can receive/obtain/acquire the RAR transmission from the wireless communication node.

In some configurations, the indication can be in a two-bit field included/indicated/provided in the RAR transmission. In some cases, the indication can indicate that the wireless communication device is (e.g., expected) to receive multiple RAR transmissions (e.g., repetitions of RAR transmissions). In some implementations, the repNum can include or be associated with a value that is the same as a maximum repetition number, where the maximum repetition number can be configured or defined via a system information block (SIB) signaling, a radio resource control (RRC) signaling, and/or a media access control control element (MAC CE) signaling, among other types of signalings.

At operation 704, the wireless communication device can determine, using at least the repNum, a time domain location of a transmission resource on which a Msg.3 transmission is to be transmitted in response to the RAR transmission

In various arrangements, the wireless communication device can determine the time domain location according to an offset (e.g., resource offset or time domain offset). For example, the wireless communication device can determine an offset using the repNum. In some cases, a value of the offset can correspond to a value of the repNum. In some other cases, the wireless communication device can use the repNum as part of a function to determine the value of the offset. Responsive to determining the offset, the wireless communication device can determine the time domain location, for instance, by adding the offset to a location of an earliest random access response (RAR) window of the RAR transmissions.

In some arrangements, the wireless communication device can determine a number of repetitions required by the wireless communication device (requiredRepNum_UE) through or based on a measurement of a synchronization signal block (SSB) and/or one or more other signals. In this case, the wireless communication device can determine the offset using the requiredRepNum_UE, and a length of a RAR window.

In some implementations, the wireless communication device can determine a number of repetitions required by wireless communication device (requiredRepNum_UE). In this case, the repNum (e.g., value of the repNum) may be the same as or may match the requiredRepNum_UE (e.g., value of the requiredRepNum of the respective wireless communication device). When the repNum=the requiredRepNum_UE, the wireless communication device can determine the offset using an approach/function/formula that uses the repNum or the requiredRepNum_UE, and a length of a RAR window.

In some implementations, the wireless communication device can send a Msg.4 transmission to only one of the multiple wireless communication devices that each sent a Msg.3 transmission to the wireless communication node. In some implementations, the wireless communication device can determine failure by a number of RAR detection attempts that exceeded the repNum (e.g., the wireless communication device attempted the detection of RAR for more than the maximum number of repetitions). Responsive to the failure by the number of RAR detection attempts, the wireless communication device can determine that a random access has failed.

In various configurations, the wireless communication device can send a Msg.3 transmission to the wireless communication node. The Msg.3 transmission can include an indication of an offset (TC-RNTI_offset) to a temporary cell radio network temporary identifier (TC-RNTI). The TC-RNTI_offset can be unique to the wireless communication device, such as different from the TC-RNTI_offset of other wireless communication devices. In some cases, the wireless communication device can determine a number of repetitions required by wireless communication device (requiredRepNum_UE). The TC-RNTI_offset can include a value that is: the same as a value of the requiredRepNum_UE, or is a function of the value of the requiredRepNum_UE.

In various implementations, the wireless communication node may scramble a content of a Msg.4 transmission using the TC-RNTI combined with the TC-RNTI_offset (e.g., according to TC-RNTI+TC-RNTI_offset). In such cases, the wireless communication device can determine whether to adopt/use the TC-RNTI combined with the TC-RNTI_offset as a cell radio network temporary identifier (C-RNTI) of the wireless communication device. For example, the wireless communication device can determine to adopt the TC-RNTI combined with the TC-RNTI_offset as its C-RNTI (e.g., in the cell of the BS), responsive to at least one of i) the wireless communication device (successfully) receiving the Msg.4 transmission from the wireless communication node (e.g., in response to its Msg.3 transmission), ii) the wireless communication device successfully descrambling the Msg.4 transmission using the TC-RNTI combined with the TC-RNTI_offset, and/or iii) the wireless communication device receiving an indication in the Msg.4 transmission from the wireless communication node, that validates/confirms/approves adoption of the TC-RNTI combined with the TC-RNTI_offset, as the C-RNTI of the wireless communication device.

In some implementations, the wireless communication node may send a respective Msg.4 transmission to each of various wireless communication devices that sent a respective Msg.3 transmission to the wireless communication node. Hence, the wireless communication devices that send the Msg.3 transmissions to the wireless communication node can complete the random access process (and adopt a CRNTI unique to each of the wireless communication devices), respectively.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node, a random access response (RAR) transmission that includes an indication indicating a maximum repetition number (repNum) of RAR transmissions for at least the wireless communication device; and
determining, by the wireless communication device using the repNum, a time domain location of a transmission resource on which a Msg.3 transmission is to be transmitted in response to the RAR transmission.

2. The method of claim 1, wherein the indication is in a two-bit field.

3. The method of claim 1, wherein the indication indicates that the wireless communication device is to receive multiple RAR transmissions.

4. The method of claim 1, wherein repNum has a value that is same as a maximum repetition number that is configured or defined via a system information block (SIB) signaling, a radio resource control (RRC) signaling, or a media access control control element (MAC CE) signaling.

5. The method of claim 1, wherein determining the time domain location comprises:
determining, by the wireless communication device, an offset using the repNum; and
determining, by the wireless communication device, the time domain location by adding the offset to a location of an earliest RAR window of the RAR transmissions.

6. The method of claim 5, comprising:
determining, by the wireless communication device, a number of repetitions required by the wireless communication device (requiredRepNum_UE) through measuring a synchronization signal block (SSB) or one or more other signals; and
determining, by the wireless communication device, the offset using the requiredRepNum_UE, and a length of a RAR window.

7. The method of claim 5, comprising:
determining, by the wireless communication device, a number of repetitions required by the wireless communication device (requiredRepNum_UE); and
determining, by the wireless communication device, the offset using the repNum or the requiredRepNum_UE, and a length of a RAR window, when the repNum matches the requiredRepNum_UE.

8. The method of claim 1, wherein the wireless communication node sends a Msg.4 transmission to only one of a plurality of wireless communication devices that each sent a Msg.3 transmission to the wireless communication node.

9. The method of claim 1, comprising:
determining, by the wireless communication device, failure by a number of RAR detection attempts that exceeded the repNum; and
determining, by the wireless communication device responsive to the failure, that a random access has failed.

10. The method of claim 1, comprising:
sending, by the wireless communication device to the wireless communication node, a Msg.3 transmission including an indication of an offset (TC-RNTI_offset) to a temporary cell radio network temporary identifier (TC-RNTI), the TC-RNTI_offset being unique to the wireless communication device.

11. The method of claim 10, comprising:
determining, by the wireless communication device, a number of repetitions required by wireless communication device (requiredRepNum_UE),
wherein the TC-RNTI_offset has a value that is: same as a value of the requiredRepNum_UE, or is a function of the value of the requiredRepNum_UE.

12. The method of claim 10, wherein the wireless communication node scrambles a content of a Msg.4 transmission using the TC-RNTI combined with the TC-RNTI offset.

13. The method of claim 12, comprising:
determining, by the wireless communication device, to adopt the TC-RNTI combined with the TC-RNTI offset, as a cell radio network temporary identifier (C-RNTI) of the wireless communication device, responsive to:
receiving the Msg.4 transmission from the wireless communication node; or
descrambling the Msg.4 transmission successfully using the TC-RNTI combined with the TC-RNTI_offset; or
receiving an indication in the Msg.4 transmission from the wireless communication node, that validates adoption of the TC-RNTI combined with the TC-RNTI_offset, as the C-RNTI of the wireless communication device.

14. The method of claim 13, wherein the wireless communication node sends a respective Msg.4 transmission to each of a plurality of wireless communication devices that sent a respective Msg.3 transmission to the wireless communication node.

15. A method comprising:
sending, by a wireless communication node to a wireless communication device, a RAR transmission that includes an indication indicating a maximum repetition number (repNum) of RAR transmissions for at least the wireless communication device,
wherein the wireless communication device determines, using the repNum, a time domain location of a transmission resource on which a Msg.3 transmission is to be transmitted in response to the RAR transmission.

16. A wireless communication node, comprising:
at least one processor configured to:
send, via a transmitter to a wireless communication device, a RAR transmission that includes an indication indicating a maximum repetition number (repNum) of RAR transmissions for at least the wireless communication device,
wherein the wireless communication device determines, using the repNum, a time domain location of a transmission resource on which a Msg.3 transmission is to be transmitted in response to the RAR transmission.

17. A wireless communication device comprising:
receiving, by a wireless communication device from a wireless communication node, a random access response (RAR) transmission that includes an indication indicating a maximum repetition number (repNum) of RAR transmissions for at least the wireless communication device; and
determining, by the wireless communication device using the repNum, a time domain location of a transmission resource on which a Msg.3 transmission is to be transmitted in response to the RAR transmission.

18. The wireless communication device of claim 17, wherein the indication is in a two-bit field.

19. The wireless communication device of claim 17, wherein the indication indicates that the wireless communication device is to receive multiple RAR transmissions.

20. The wireless communication device of claim 17, wherein repNum has a value that is same as a maximum repetition number that is configured or defined via a system information block (SIB) signaling, a radio resource control (RRC) signaling, or a media access control control element (MAC CE) signaling.
